(19) United States
(12) Patent Application Publication
(10) Pub. No.: US 2026/0323796 A1
(43) Pub. Date: Oct. 15, 2026

(54) TWO-STEP TEMPERATURE COMPENSATION

(71) Applicant: ams-OSRAM International GmbH, Regensburg (DE)

(72) Inventors: Daniel DIETZE, Regensburg (DE); Massimo RIGO, Trieste (IT)

(21) Appl. No.: 19/485,283

(22) PCT Filed: Aug. 23, 2024
(86) PCT No.: PCT/EP2024/073689

§ 371 Date: Nov. 18, 2025

(30) Foreign Application Priority Data
Nov. 21, 2023 (DE) 10 2023 132 420.9

(51) Int. Cl. H05B 45/18; H05B 45/325

(52) U.S. Cl. CPC H05B 45/18; H05B 45/325

(57) ABSTRACT

The present disclosure relates to a light emitting device (100) including: a light emitting element (102) configured to emit light (104); and a driver circuit (106) configured to: receive a temperature-compensated working point (112) for defining a driving profile (116) for driving a light emission by the light emitting element (102), wherein the temperature-compensated working point (112) is determined by an external electronic device disposed externally to the light emitting device (100); get a temperature value of a temperature of the light emitting device (100); define the driving profile (116) based on the temperature-compensated working point (112) and on the temperature value of the temperature of the light emitting device (100); and generate driving current for driving the light emitting element (102) according to the defined driving profile (116).

### TECHNICAL FIELD

The present disclosure relates generally to an adapted temperature-compensation scheme for driving a light emitting device, and to methods thereof (e.g., a method of driving a light emitting device according to an adapted temperature-compensation scheme)

### BACKGROUND

In general, lighting fixtures and display devices are present in a wide range of technical contexts and applications, e.g. for illuminating an environment, for displaying images, and the like. Two approaches are commonly used for driving the light emission. A first approach is based on modulation in time, preferably via pulse width modulation (PWM), where a driving current is maintained at a constant value, and the ratio between on-time and off-time is varied to create a different impression of brightness. A second approach is based on amplitude modulation, in which the current is varied for each brightness value. Combinations of the two approaches are also known, where discrete amplitude settings are combined with PWM. However, temperature oscillations of the light emitter may cause a deterioration of the properties of the emitted light, such as a shift in the emitted color and a reduced brightness. Temperature variations may thus lead to a light output that deviates from an intended operation of the light emitter. There is thus a need for improvements in temperature-compensation schemes for light emitting devices, which may be of particular relevance for the further advancement of several technologies.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various aspects of the invention are described with reference to the following drawings, in which:

FIG. 1A to FIG. 1C show a light emitting device, in a schematic representation according to various aspects;

FIG. 2 shows an electronic device in a schematic representation according to various aspects;

FIG. 3A to FIG. 3C show various aspects of a temperature-compensated working point and of a driving profile for driving light emission by a light emitting element, according to various aspects;

FIG. 4A and FIG. 4B show a system including a light emitting device and an external electronic device communicatively coupled with one another, in a schematic representation according to various aspects;

FIG. 5 shows an exemplary realization of the system including the light emitting device and the external electronic device, in a schematic representation according to various aspects;

FIG. 6A shows a message flow between a light emitting device and an external electronic device communicatively coupled with one another for temperature compensation, according to various aspects; and

FIG. 6B shows a schematic flow diagram of a method of carrying out temperature-compensated light emission, according to various aspects.

### DESCRIPTION

The following detailed description refers to the accompanying drawings that show, by way of illustration, specific details and aspects in which the invention may be practiced. These aspects are described in sufficient detail to enable those skilled in the art to practice the invention. Other aspects may be utilized and structural, logical, and electrical changes may be made without departing from the scope of the invention. The various aspects are not necessarily mutually exclusive, as some aspects may be combined with one or more other aspects to form new aspects. Various aspects are described in connection with methods and various aspects are described in connection with devices (e.g., a light emitting device, a driver circuit, an external electronic device, a processor, etc.). However, it is understood that aspects described in connection with methods may similarly apply to the devices, and vice versa.

In general, a commonly used driving scheme for controlling the delivery of electrical energy (e.g., current or voltage) from a power supply to a load is the so-called pulse width modulation (PWM), which may be applied for controlling light emitting elements (e.g., LEDs), motors, battery chargers, solar panels, and the like. The PWM technique is based on pulsing the power supply on and off at a certain frequency and with a certain pulse width, thus allowing to control the amount of electrical energy delivered to the load over a certain period of time, illustratively the average power delivered to the load. In general, the PWM driving scheme is well known in the art. Some basic concepts are described herein to introduce aspects relevant for the present disclosure.

As an abridged overview, PWM may describe the use of a digital signal to obtain an analog result. The PWM signal may be a square wave switched between a high state (illustratively, an “on state”) and a low state (“off state”). The percentage of time in which the PWM signal is in the high state is the so-called duty cycle. By way of illustration, a PWM signal always on would have a 100% duty cycle, a PWM signal always off would have a 0% duty cycle, a PWM signal on for half of a period would have a 50% duty cycle, and so on. In addition to the duty cycle, another important parameter of a PWM signal is the frequency of the waveform, i.e. the inverse of the period, i.e. the inverse of the complete on-time and off-time of the PWM signal. By controlling the duty cycle of the PWM signal it is possible to control the electrical power perceived by a load. Illustratively, by varying the duty cycle (the relative on-time), the average voltage of the signal may vary accordingly.

A relevant use case for the PWM technique is the control of the brightness of light emitted by a light emitting diode (LED), the so-called “dimming”. With PWM, a LED is turned on and off with a duty cycle and frequency defined by the PWM signal. By varying the on-time, the brightness of the emitted light as perceived by the human eye may be varied accordingly. The frequency of the PWM signal should be sufficiently high to avoid flickering, i.e. the on/off frequency should be faster than the perception of the human eye (the so-called Flicker Fusion Rate). For LED dimming, the frequency of a PWM signal may be for example around 100 Hz.

Illustratively, a LED may have an amount of power for which the LED produces a maximum output (e.g., light at maximum brightness). The PWM technique is based on switching the LED on and off at high frequency so that the power perceived by the LED varies in a range between 0 and the amount of power corresponding to the maximum output, thus regulating the brightness as a function of the ratio of the on-time to off-time. PWM may thus provide a relatively simple scheme to adjust the LED's brightness.

Another approach to LED dimming is the so-called constant current reduction (CCR), in which the LED is maintained constantly on, and the current level of the current delivered to the LED is adjusted to change the brightness of the emitted light. The CCR technique provides thus an “analog dimming”, in which the amplitude of the current is increased or decreased to cause a corresponding increase or decrease in the LED's brightness.

In this context, a common issue related to light emission is a shift in the light emitting properties caused by changes in the temperature at which the light emitting device operates. Illustratively, when the light emitting device heats up (e.g., during a prolonged operation, or due to changes in the environment) the properties of the emitted light may deteriorate, for example the brightness may decrease and/or the color may slightly vary. Such temperature-induced variations may occur in various types of light emitting devices, and may be of particular relevance in the context of light emitting diodes with an integrated driver circuit.

Various temperature-compensation schemes have been developed to maintain a stable light output even in presence of temperature oscillations. A simple approach may consist in a built-in compensation of PWM values based on a look-up table. In the “full built-in compensation” scenario, the driver circuit of the light emitting device (e.g., the LED driver) may have a built-in temperature sensor or forward voltage (V_{F}) sensor, and the result of the sensing process is used to look up compensation parameters in an on-board look-up table.

Another approach may consist in a purely external compensation carried out by an external controller. In the “no built-in compensation” scenario, the result of the temperature sensing or forward voltage sensing is used by the external controller (e.g., an external microcontroller) to calculate temperature compensated PWM values. This allows to compensate the LEDs' calibration data before calculating the PWM values, allowing optimal compensation over the full gamut.

However, both the “full built-in compensation” and the “no built-in compensation” approaches present shortcomings that limit their efficiency and applicability. In particular, built-in compensation is not capable of providing a color quality as high as the case in which the temperature calibration is driven by an external controller, unless large hardware is used replicating the controller function in the driver circuit. This is however not economically viable for small foot-print, low cost drivers. In addition, the full built-in approach only allows to compensate PWM values, giving satisfactory compensation only close to the reference color point that was originally used to create the look-up table. For example, the full built-in compensation may be based on a linear scaling, which works properly only for certain points (e.g., only for a certain color coordinate). On the other hand, with no built-in compensation, regular updates of PWM settings are required, especially at fast color and intensity transitions, leading to significant overhead on the external controller. Illustratively, a relatively large amount of data are transferred between the light emitting device and the external controller.

The present disclosure is related to a hybrid temperature-compensation scheme for driving light emission. The hybrid temperature-compensation scheme may combine aspects of the “full built-in compensation” and aspects of the “no built-in compensation” to overcome the respective deficiencies and provide a flexible and accurate temperature-compensated light emission. In particular, the hybrid temperature-compensation scheme may include a first processing carried out in an external electronic device (e.g., an external controller) and a second processing carried out internally at the light emitting device (e.g., by the driver). The proposed approach may thus be based on splitting the temperature compensation in two steps, one carried out externally and one carried out internally to the light emitting device.

The combination of external and internal temperature compensation allows an accurate definition of a working point by exploiting the computational capabilities of the external processor, and further allows reducing the computational load on the external circuit by leaving the fine adjustments around the working point to the internal driver circuit of the light emitting device. The proposed hybrid compensation may thus include an external loop to set an initial compensation (e.g., for ambient correction) and an additional internal loop to compensate for smaller temperature changes (e.g., caused by self-heating). In some aspects, the internal loop may be based on a programmable linear correction factor for each channel and a flexible reference temperature (e.g., set automatically when engaging the loop). For example, the internal loop may be engaged by a temperature threshold or a regular timer interval, which may be fixed or programmable.

The hybrid temperature compensation scheme may thus include calculating the optimal working point for light emission (e.g., for the LEDs) based on the temperature of the light emitting device, and then engage an internal regulation (e.g., a linear regulation) around the externally-defined working point. The proposed scheme may be based on the realization that the internal driver is capable of efficiently compensating around a defined working point (e.g., to compensate a loss of brightness), whereas an external circuit with greater computational power is more suitable to identify the working parameters that provide a desired color coordinate. The external loop may thus provide optimal temperature correction over the full gamut, and the internal loop may automatically correct any color changes due to self-heating without additional communication with the external controller, thus maintaining a low data traffic.

According to various aspects a light emitting device may include: a light emitting element configured to emit light; and a driver circuit configured to: receive a temperature-compensated working point for defining a driving profile for driving a light emission by the light emitting element, wherein the temperature-compensated working point is generated by an external electronic device disposed externally to the light emitting device; get a temperature value of a temperature of the light emitting device (e.g., a temperature value of a temperature of the light emitting element); define the driving profile based on the temperature-compensated working point and on the temperature value of the temperature of the light emitting device; and generate driving current for driving the light emitting element according to the defined driving profile.

According to various aspects a system may include: a light emitting device and an external electronic device disposed externally to the light emitting device, wherein the light emitting device and the external electronic device are communicatively coupled with one another; wherein the light emitting device includes a light emitting element configured to emit light and a driver circuit configured to drive a light emission of the light emitting element; wherein the external electronic device includes a processor configured to: receive a temperature signal indicative of a temperature of the light emitting device; determine, based on a temperature value of the temperature of the light emitting device, a temperature-compensated working point for defining a driving profile for driving a light emission by the light emitting element; and transmit the determined temperature-compensated working point to the driver circuit of the light emitting device; wherein the driver circuit of the light emitting device is further configured to: receive the temperature-compensated working point; get a (further) temperature value of the temperature of the light emitting device; define the driving profile based on the temperature-compensated working point and on the (further) temperature value of the temperature of the light emitting device; and generate driving current for driving the light emitting element according to the defined driving profile.

According to various aspects a method of temperature-compensated light emission may be provided, the method including: receiving at a light emitting device a temperature-compensated working point for defining a driving profile for driving a light emission by a light emitting element of the light emitting device, wherein the temperature-compensated working point is generated externally to the light emitting device; defining at the light emitting device the driving profile based on the temperature-compensated working point and on a temperature value of a temperature of the light emitting device; and generating driving current for driving the light emitting element according to the defined driving profile.

According to various aspects a method of temperature-compensated light emission may be provided, the method including: determining, externally to a light emitting device and based on a temperature value of a temperature of the light emitting device, a temperature-compensated working point for defining a driving profile for driving a light emission by a light emitting element of the light emitting device; receiving at the light emitting device the temperature-compensated working point; defining at the light emitting device the driving profile based on the temperature-compensated working point and on a (further) temperature value of the temperature of the light emitting device; and generating driving current for driving the light emitting element according to the defined driving profile.

The proposed scheme may allow compensating temperature-induced changes in brightness and chromaticity of one or more light emitting elements (e.g., LEDs), and may allow obtaining compensation factors in a resource- and time-efficient manner. The proposed strategy may be of particular relevance for RGB LEDs with integrated driver integrated circuit (IC) and stand-alone drivers where excellent color stability is required, and the IC may provide the necessary built-in functionality. It is however understood that the proposed approach may be applied also to other types of light emitting elements, such as Vertical Cavity Surface Emitting Lasers (VCSELs). In case of a light emitting device including a plurality of light emitting elements, the temperature-compensation may provide a correction factor for each channel, and a flexible reference temperature (e.g., set automatically when engaging the loop).

The proposed scheme may allow obtaining perfectly stable mixed and pure colors in the whole accessible gamut over the full temperature range, while maintaining reduced communication traffic, which may be of particular relevance in long daisy chain configurations.

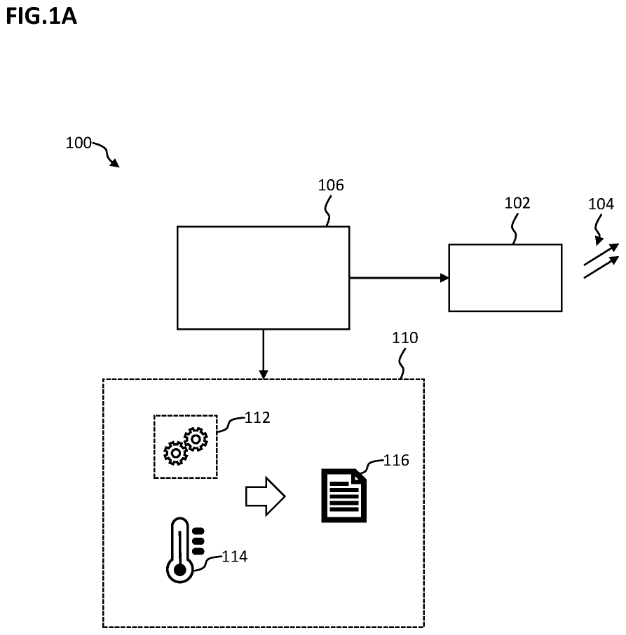

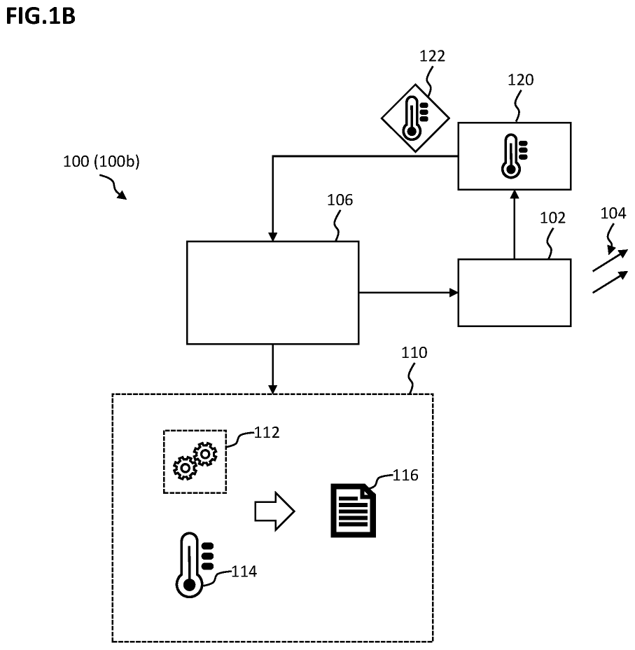

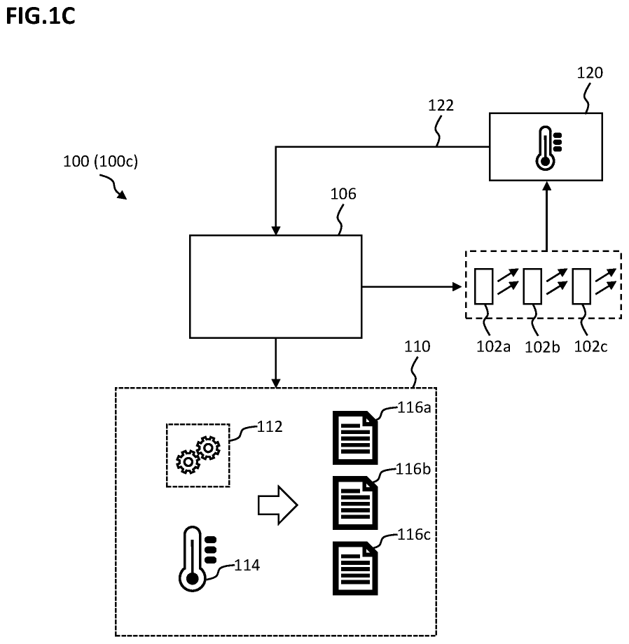

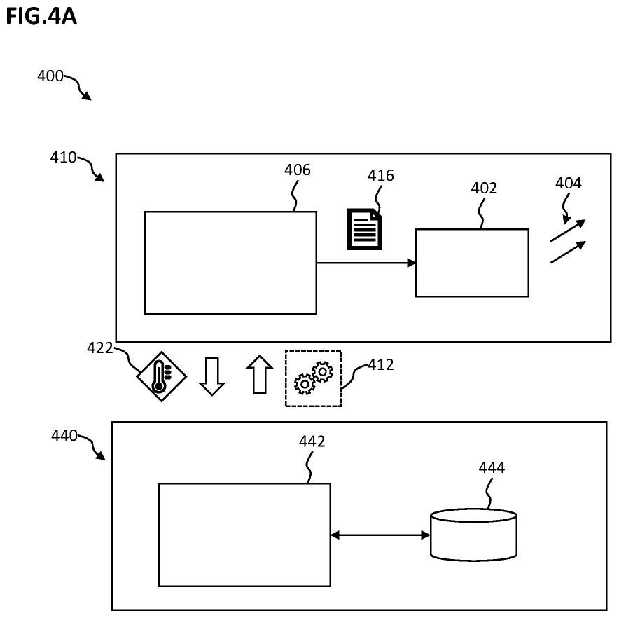

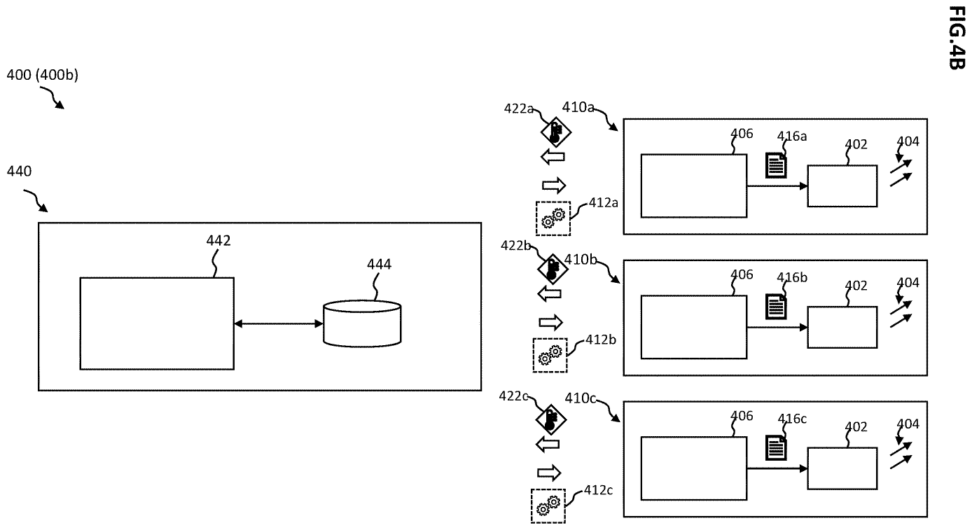

FIG. 1A to FIG. 1C show a light emitting device 100 in a schematic representation according to various aspects. The light emitting device 100 may be configured to implement an adapted temperature compensation scheme for light emission, as discussed in further detail below. The light emitting device 100 may be a standalone device or may be part of an arrangement with a plurality of light emitting devices (see also FIG. 4B). For example, a display may include the light emitting device 100 (e.g., as a pixel of the display). As another example, a lighting fixture may include the light emitting device 100 (e.g., together with a plurality of further light emitting devices, for example connected in a daisy chain configuration). As a further example, a headlight of a vehicle may include the light emitting device 100.

It is understood that the representation of the light emitting device 100 in FIG. 1A to FIG. 1C may be simplified for the purpose of illustration, and the light emitting device 100 may include additional components with respect to those shown.

In general, the light emitting device 100 may include a light emitting element 102 configured to emit light 104. In principle, the emitted light 104 may have any suitable wavelength. In a preferred configuration, for which the temperature compensation may be of particular relevance, the light emitting element 102 may be configured to emit light 104 having wavelength in the visible wavelength range (e.g., from about 380 nm to about 700 nm). As other examples, the light emitting element 102 may be configured to emit light 104 having wavelength in the infrared and/or near-infrared range (e.g., in the range from about 700 nm to about 5000 nm), or ultraviolet range (e.g., from about 100 nm to about 400 nm).

The light emitting element 102 may have any suitable configuration. In a preferred configuration, the light emitting element 102 may be or include a light emitting diode (LED). LEDs are widely adopted in view of their advantageous properties such as energy efficiency, eye safety, design flexibility, durability, etc. However, LEDs may suffer from variations in the light output due to temperature variations, so that the strategy proposed herein may be particularly suitable for use in the context of LED-based systems.

It is however understood that the strategy proposed herein may also be applied to other types of light emitting elements. As other examples, the light emitting element 102 may be or include an edge-emitting laser, a surface-emitting laser, a semiconductor laser, a VCSEL, a Vertical-External-Cavity Surface-Emitting Laser (VECSEL), a superluminescent LED, and the like.

The light emitting device 100 may further include a driver circuit 106 configured to drive the light emitting element 102, illustratively the driver circuit 106 may drive/control the light emission by the light emitting element 102. Considering the scenario in which the light emitting element 102 is or includes a LED, the driver circuit 106 may be a LED driver. In general, the driver circuit 106 may be configured to provide power to the light emitting element 102 to allow the light emitting element 102 to emit light 104. The driver circuit 106 may thus be configured to deliver sufficient current to enable light emission by the light emitting element 102.

As generally known in the art, a driver circuit 106 may couple a light emitting element 102 to a power supply, and may be configured to convert a (high) supply voltage alternating current from the power supply into a (lower) voltage direct current delivered to the light emitting element 102. In a preferred configuration, the driver circuit 106 may be a constant voltage driver circuit (e.g., a constant voltage LED driver), illustratively configured to maintain a regulated constant voltage across the load (the light emitting element 102).

The driver circuit 106 may include any suitable components for regulating the amount of power delivered to the light emitting element 102. As exemplary components, the driver circuit 106 may include one or more switch elements (e.g., one or more transistors, such as Metal Oxide Semiconductor Field-effect Transistors, MOSFETs), one or more capacitors, one or more resistors, one or more filters (e.g., input filter and/or output filter), one or more diodes (e.g., Zener diodes), one or more rectifiers, and the like. The specific architecture and the specific dimensioning of the components may be adapted depending on the type of light emitting element 102, and on the intended operation of the light emitting element 102.

The driver circuit 106 may include or may be coupled with a supply source (not shown) configured to generate a supply voltage. In an exemplary configuration, the supply source may be internal to the light emitting device 100, e.g. part of the driver circuit 106 or external to the driver circuit 106 (and simply coupled to the driver circuit 106 at a supply terminal). For example the supply source may be a battery in this case. In another configuration the supply source may be external to the light emitting device 100, and the light emitting device 100 (and accordingly the driver circuit 106) may be coupled with the external supply source. For example, considering an installation in a vehicle, the external supply source may be a battery unit of the vehicle. In general, the driver circuit 106 may be configured to receive the supply voltage and generate driving power (e.g., a driving current) for the light emitting element 102 from the supply voltage.

In a preferred configuration, the light emitting device 100 may be an integrated circuit device, e.g. a semiconductor integrated circuit. In this scenario, the driver circuit 106 and the light emitting element 102 may be integrated on a semiconductor substrate (e.g., a silicon substrate), forming an integrated circuit, also referred to as chip. Further additional components of the light emitting device 100 may also be integrated on the semiconductor substrate (e.g., a temperature sensor, see FIG. 1B). In this configuration, the driver circuit 106 may be referred to as driver integrated circuit (driver IC).

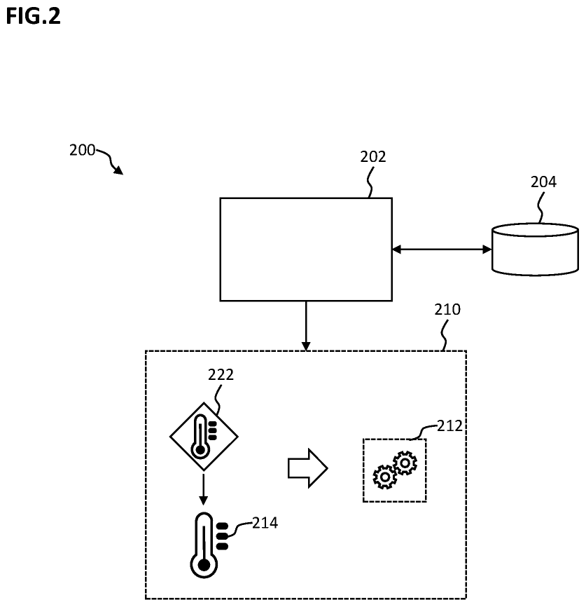

According to the temperature-compensation scheme proposed herein, the driver circuit 106 may be configured to carry out an internal temperature compensation based on the result of an external temperature compensation carried out by an external electronic device (see also FIG. 2). The driver circuit 106 may thus be configured to perform an adapted method 110 of temperature-compensated driving of the light emitting element 102. As an exemplary configuration, a firmware of the light emitting device 100 may include instructions (e.g., microcode) that cause the driver circuit 106 to operate according to the adapted method 110.

Aspects described with respect to a configuration of the driver circuit 106 may also apply to the method 110, and vice versa. Illustratively, a functionality carried out by the driver circuit 106 may correspond to a respective step of the method 110, and a step of the method 110 may correspond to a respective configuration of the driver circuit 106 to carry out a functionality resulting in the method step.

In a preferred configuration, considering typical application scenarios, the driver circuit 106 may be configured to carry out hardware-based processing to implement the temperature-compensation scheme (illustratively, to implement the method 110), e.g. to define a driving profile 116 for driving the light emission by the light emitting element 102. Illustratively, the driver circuit 106 may include specialized hardware configured for implementing the method 110. As an example, the driver circuit 106 may include an Application Specific Integrated Circuit (ASIC) configured to implement the method 110.

According to the adapted temperature-compensation scheme, the driver circuit 106 may be configured to receive a temperature-compensated working point 112 generated by an external electronic device disposed externally to the light emitting device 100. The temperature-compensated working point 112 may be for defining a driving profile 116 for driving the light emission by the light emitting element 102. The driver circuit 106 may receive the temperature-compensated working point 112 directly from the external electronic device that generated the temperature-compensated working point 112. As another example, the driver circuit 106 may receive the temperature-compensated working point 112 from an intermediate device that is communicatively interposed between the light emitting device 100 and the external electronic device that generated the temperature-compensated working point 112. A “temperature-compensated working point” may also be referred to herein as “temperature-compensated set point”, or simply as “working point” or “set point”.

Illustratively, the light emitting device 100 may include a communication interface (not shown) configured to enable a communicative coupling between the light emitting device 100 and the external electronic device (illustratively, an external circuit), or between the light emitting device 100 and the intermediate device. As will be described in further detail in relation to FIG. 4A and FIG. 4B, the communication interface may be a wired communication interface for wired communication or a wireless communication interface for wireless communication. The driver circuit 106 may receive a signal representative of the temperature-compensated working point 112 via the communication interface.

According to the adapted temperature-compensation scheme, the driver circuit 106 may be further configured to get (e.g., receive, retrieve, acquire, obtain) a temperature value 114 of a temperature of the light emitting device 100. For example, the driver circuit 106 may be configured to receive a measurement signal representative of the temperature value 114. The temperature value 114 may represent the temperature at which the light emitting device 100 is currently operating. For example, the temperature value 114 may be the temperature value of temperature of the light emitting element 102, illustratively of the current operating temperature of the light emitting element 102. In a first approximation, the temperature of the light emitting element 102 may be assumed to be equal as the temperature of the light emitting device 100. In the following, aspects described in relation to a “temperature of a light emitting device” may correspondingly apply to a “temperature of a light emitting element”, and vice versa.

The temperature value 114 may include an instantaneous temperature value, e.g. at a certain time point, e.g. at the time point at which the driver circuit 106 gets the measurement signal. As another example, the temperature value 114 may include an average temperature value, e.g. an average of a plurality of temperature values over a predefined time period. For example, the average temperature value may include the average of a number N of temperature values at N time points preceding the time point at which the driver circuit 106 gets the measurement signal. Any suitable number of temperature values may be considered for the average, e.g. N may be two, three, four, five, ten, or more than ten. In a corresponding manner, the predefined time period for averaging the temperature may have any suitable (short) duration, e.g. a duration in the range from 10 s (seconds) to 10 minutes, for example a duration from 30 s to 5 minutes, for example a duration from 45 s to 2 minutes. The N temperature values may represent the temperature of the light emitting device 100 (e.g., the temperature of the light emitting element 102) at regular time intervals within the predefined time period.

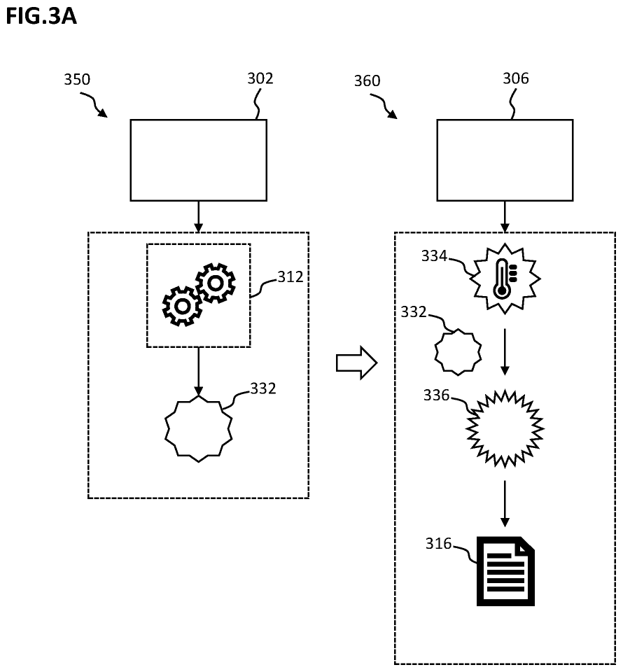

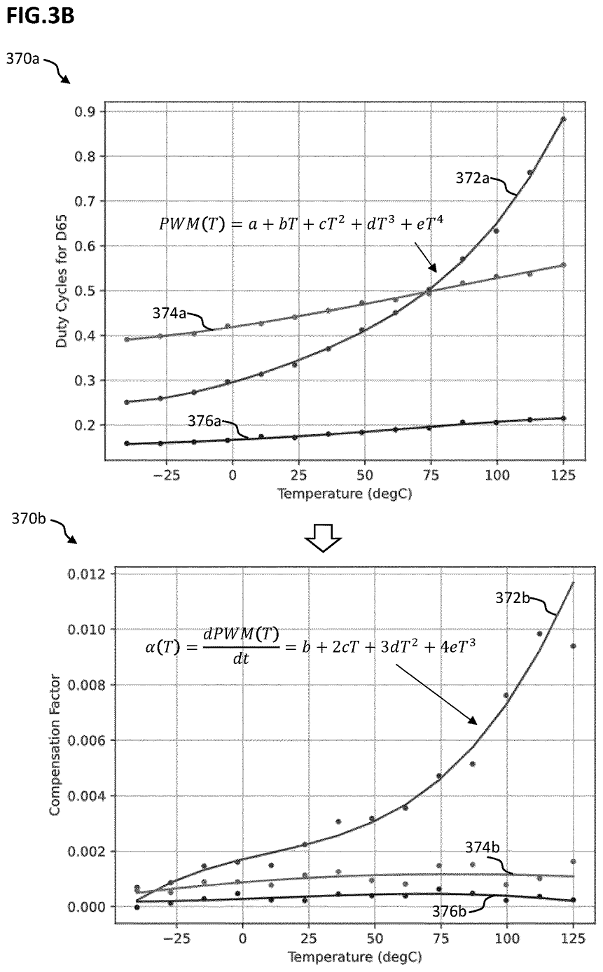

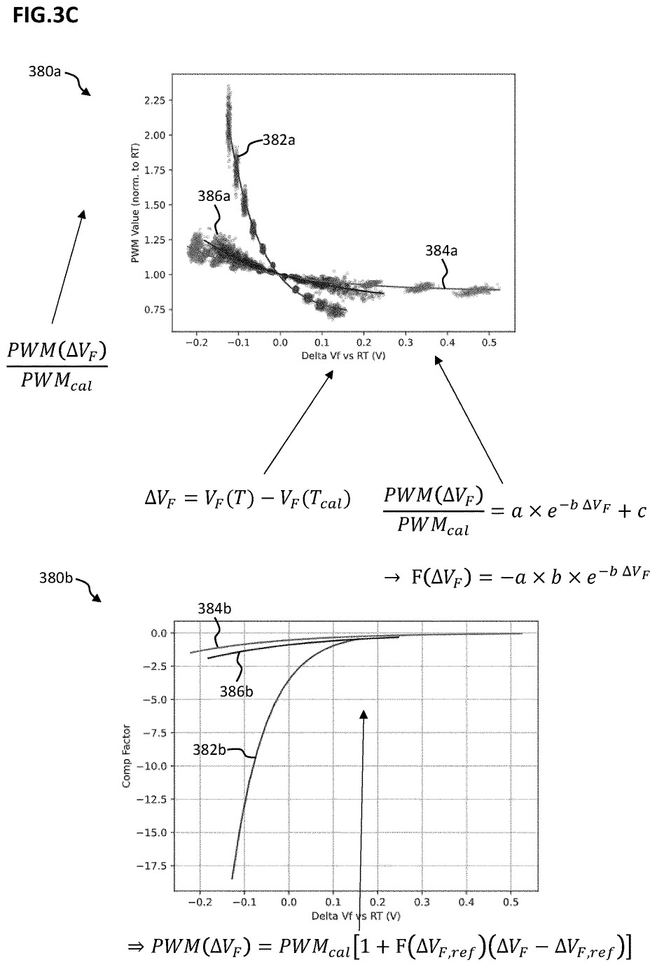

The driver circuit 106 may be further configured to define the driving profile 116 for driving the light emission by the light emitting element 102 based on the temperature-compensated working point 112 and on the temperature value 114. Illustratively, the temperature-compensated working point 112 may provide an initial adjustment of how to drive the light emitting element 102, and the driver circuit 106 may further tune the driving parameters around the temperature-compensated working point 112 to provide a more accurate temperature compensation (see also FIG. 3A to FIG. 3C).

The driving profile 116 may include a set of parameters defining the delivery of current to the light emitting element 102. The driving profile 116 may illustratively include current generation parameters defining a driving condition (for the light emitting element 102) that compensates the effect of the temperature. The driving profile 116 may also be referred to herein as driving current profile.

The current generation parameters may define any suitable property of the current generation/current delivery. For example, the current generation parameters may define a current value of a driving current to be generated/delivered to the light emitting element 102. As another example, additionally or alternatively, the current generation parameters may define a timing of the current generation/delivery (e.g., a start time, an end time, a duration). As a further example, additionally or alternatively, the current generation parameters may define a plurality of current values, each associated with a respective time interval, such that a first current with a first current value is generated/delivered in a first time interval, a second current with a second current value (different from the first current value) is generated/delivered in a second time interval, etc. Illustratively, the current generation parameters may define an amplitude modulation of the driving current.

In a preferred configuration, the current generation parameters may include pulse width modulation (PWM) parameters for generating the driving current for the light emitting element 102. The PWM parameters may specify, for example, the duty cycle of the PWM signal, the frequency of the PWM signal, and/or any suitable PWM parameter. In this scenario, the PWM parameters may be temperature-compensated PWM parameters by the initial external compensation supplemented by the subsequent internal compensation.

The driver circuit 106 may be further configured to drive the light emission by the light emitting element 102 according to the (temperature-compensated) driving profile 116, illustratively according to the current generation parameters. The driver circuit 106 may thus be configured to generate driving current according to the driving profile 116 and deliver the driving current to the light emitting element 102 to cause a (temperature-compensated) light emission by the light emitting element 102. As mentioned, in a preferred configuration the driver circuit 106 may be configured to generate the driving current according the PWM parameters defined in the driving profile 116.

From the perspective of the method 110, the method 110 may include receiving at the light emitting device a temperature-compensated working point 112 for defining a driving profile for driving a light emission by a light emitting element 102 of the light emitting device 100, wherein the temperature-compensated working point 112 is generated by an external electronic device disposed externally to the light emitting device 100. The method 110 may further include defining at the light emitting device 100 the driving profile 116 based on the temperature-compensated working point 112 and on a temperature value 114 of a temperature of the light emitting device (e.g., a temperature of the light emitting element 102). The method 110 may further include generating driving current according to the driving profile 116 and delivering the driving current to the light emitting element 102 to cause a (temperature-compensated) light emission.

It is understood that further properties of the temperature may be considered in addition to the temperature value 114 for the proposed temperature-compensated light emission. Illustratively, defining the driving profile 116 based on a temperature value 114 may provide a preferred configuration, which may be implemented in a resource-efficient manner also using relatively simple circuitry. In some aspects, the driver circuit 106 may be further configured to determine the driving profile 116 further based on additional temperature parameters. The additional temperature parameters may include, for example, a slope of the temperature (illustratively, a speed of a temperature variation), a gradient of the temperature, a maximum temperature value in a predefined time interval, a minimum temperature value in a predefined time interval, or any combination thereof.

In general, there may be various ways for the driver circuit 106 to get the temperature value 114, e.g. to get an instantaneous temperature value or average temperature value of the temperature of the light emitting device 100. In the proposed strategy, the temperature value 114 may be determined internally to the light emitting device 100, thus enhancing the accuracy of the temperature determination, and accordingly of the temperature compensation.

According to various aspects, as shown in the configuration 100b in FIG. 1B, the electronic device 100 may further include a temperature sensor 120 configured to sense the temperature of the electronic device 100. For example, the temperature sensor 120 may be configured to sense the temperature of the light emitting element 102. The temperature sensor 120 may be further configured to transmit a measurement signal 122 representative of the temperature to the driver circuit 106. The measurement signal 122 may be representative of the temperature value 114, and of any suitable temperature parameter depending on the configuration of the light emitting device 100. The temperature sensor 120 may have any suitable configuration. For example, the temperature sensor 120 may be a semiconductor-based temperature sensor. As an exemplary realization the temperature sensor 120 may include a thermistor.

In some aspects, the temperature sensor 120 may be configured to transmit the measurement signal 122 to the driver circuit 106 at predefined time intervals, e.g. at regular time intervals, for example every 10 s, every 30 s, every minute, every 5 minutes, and the like. In other aspects, the temperature sensor 120 may be configured to transmit the measurement signal 122 (only) in response to a prompt from the driver circuit 106. Illustratively, the driver circuit 106 may be configured to send a request to the temperature sensor 120 to cause the temperature sensor 120 to sense the temperature and transmit a corresponding measurement signal 122 to the driver circuit 106.

The use of a temperature sensor 120 is however not the only option for monitoring the temperature, e.g. for determining (e.g., estimating) the temperature value 114. As an alternative configuration, the driver circuit 106 may be configured to determine the temperature value 114 as a function of a voltage at driver terminals of the light emitting element 102. In this scenario, the temperature may be monitored/determined indirectly, based on the voltage used/necessary for enabling the light emission by the light emitting element 102. For example, the light emitting device 100 may further include a voltage sensor configured to sense the voltage at the driver terminals and transmit to the driver circuit 106 a corresponding measurement signal representative of the voltage (and accordingly representative of the temperature).

This type of voltage-based temperature determination may be provided in alternative or in addition to the temperature sensing via the temperature sensor 120. For example, to save space on chip, the light emitting device 100 may be free of the temperature sensor 120 and the temperature determination may be based solely on the voltage at the driver terminals of the light emitting element 102. As another example, to provide a more flexible and accurate temperature determination, the light emitting device 100 may include both the temperature sensor 120 and a voltage sensor. In this case, the driver circuit 106 may determine the temperature value 114 using one of the two options based on a current scenario, or using both options (e.g., as an average of the temperature sensed by the temperature sensor 120 and of the temperature determined via the voltage measurement).

In the exemplary case in which the light emitting element 102 includes a LED, the driver circuit 106 may be configured to determine the temperature value 114 based on the forward voltage of the LED. The driver circuit 106 may determine the temperature value 114 based on a known temperature dependence of the forward voltage to the temperature, thus associating the value of the forward voltage (to obtain light emission) to a corresponding temperature value 114. Only as an example, the driver circuit 106 may retrieve from a look-up table stored in a memory of the light emitting device 100 a corresponding temperature value based on the forward voltage value.

As an example, the driver circuit 106 may compare the LED forward voltage to a reference value for the forward voltage (measured in static conditions), and may determine the temperature value 114 based on the difference between the LED forward voltage and the reference value for the forward voltage. Illustratively, the reference value for the forward voltage may correspond to a reference temperature, and the difference between the forward voltages may correspond to a temperature difference. The static conditions may include, for example, negligible self-heating and LED temperature assumed equal to absolute temperature measurement on system level.

The LED forward voltage may be used instead of a direct temperature reading to define the driving profile 116 (e.g., to calculate the PWM correction factor). This configuration may be particularly advantageous, without limitation, if thermal coupling between the LED and the driver or ambient is low or difficult to predict, or if a temperature sensor is not available.

According to various aspects, the light emitting device 100 may include more than one light emitting element 102, as shown in the configuration 100c in FIG. 1C. In this configuration, the light emitting device 100 includes a plurality of light emitting elements, e.g. a first light emitting element 102a, a second light emitting element 102b, a third light emitting element 102c, etc. In a preferred configuration the plurality of light emitting elements may include exactly three light emitting elements 102a, 102b, 102c (emitting light with different colors). It is however understood that the plurality of light emitting elements may include any suitable number of light emitting elements, e.g. two, three, four, five, or more than five. In general, the light emitting elements 102a, 102b, 102c may be configured as the light emitting element 102. In a preferred configuration, the light emitting elements 102a, 102b, 102c may be a plurality of LEDs, as discussed above.

According to various aspects, each light emitting element 102a, 102b, 102c may be configured to emit light in a respective wavelength range. For example the first light emitting element 102a may be configured to emit light in a first wavelength range (e.g., a first color, for example blue), the second light emitting element 102b may be configured to emit light in a second wavelength range (e.g., a second color, for example red), and the third light emitting element 102c may be configured to emit light in a third wavelength range (e.g., a third color, for example green), etc.

In this configuration, the driver circuit 106 may be configured to define a plurality of driving profiles 116a, 116b, 116c, illustratively a respective driving profile for each light emitting element 102a, 102b, 102c. Considering the exemplary case in FIG. 1C, the driver circuit 106 may define a first driving profile 116a for the first light emitting element 102a, a second driving profile 116b for the second light emitting element 102b, a third driving profile 116c for the third light emitting element 102c, etc. The driver circuit 106 may further generate (and deliver) driving current to the light emitting elements 102a, 102b, 102c according to the respective driving profile 116a, 116b, 116c.

In this scenario, the temperature-compensated working point 112 may include a single working point common to the light emitting elements 102a, 102b, 102c, or the temperature-compensated working point 112 may include a respective working point for each of the light emitting elements 102a, 102b, 102c. In a corresponding manner, the temperature value 114 may include a single temperature value common to the light emitting elements 102a, 102b, 102c (under the assumption that element-to-element temperature variations may be negligible), or may include a respective temperature value for each of the light emitting elements 102a, 102b, 102c.

For example, in case the temperature-compensated working point 112 includes a single working point, the temperature value 114 may include a plurality of temperature values, and the driver circuit 106 may define the respective driving profile 116a, 116b, 116c for the light emitting elements 102a, 102b, 102c based on the common working point and the respective temperature value. As another example, in case the temperature-compensated working point 112 includes a plurality of working points, the temperature value 114 may include a single temperature value, and the driver circuit 106 may define the respective driving profile 116a, 116b, 116c for the light emitting elements 102a, 102b, 102c based on the respective working point and the common temperature value. As another example, in case the temperature-compensated working point 112 includes a plurality of working points and the temperature value 114 includes a plurality of temperature values, the driver circuit 106 may define the respective driving profile 116a, 116b, 116c for the light emitting elements 102a, 102b, 102c based on the respective working point and the respective temperature value.

In the exemplary configuration in FIG. 1C, the light emitting device 100 is illustrated with a temperature sensor 120. As an exemplary configuration, the temperature sensor 120 may be configured to sense a common temperature for the plurality of light emitting elements 102a, 102b, 102c (and deliver a corresponding measurement signal 122 to the driver circuit 106), e.g. a common temperature value. As another exemplary configuration, the temperature sensor 120 may be configured to sense a plurality of individual temperatures (e.g., individual temperature values), one for each of the light emitting elements 102a, 102b, 102c. In this case, the temperature sensor 120 may include a plurality of temperature sensors, each dedicated to sensing the temperature of a respective light emitting element 102a, 102b, 102c.

It is however understood that, in other aspects, the configuration with a plurality of light emitting elements 102a, 102b, 102c may be provided in absence of a temperature sensor 120. In this case, the driver circuit 106 may be configured to determine the temperature (e.g., the temperature value) based on the voltage at the driver terminals of the light emitting elements 102a, 102b, 102c. For example, the driver circuit 106 may be configured to determine a respective temperature value for a light emitting element 102a, 102b, 102c based on a respective voltage at the driver terminals of that light emitting element 102a, 102b, 102c. Considering LEDs, the driver circuit 106 may be configured to determine a respective temperature value for a light emitting element 102a, 102b, 102c based on a respective forward voltage of that light emitting element 102a, 102b, 102c. As another example, the driver circuit 106 may be configured to determine a single temperature value for the plurality of light emitting elements 102a, 102b, 102c, e.g. using the voltage at the terminals of just one of the light emitting elements, or using an average voltage corresponding to an average of the individual voltages, as examples.

The temperature-compensation scheme will now be described from the perspective of the external electronic device. In this regard, FIG. 2 shows an electronic device 200, in a schematic representation according to various aspects. In general, the electronic device 200 may be configured to determine a temperature-compensated working point 212 for light emission by a light emitting device (external to the electronic device 200). The electronic device 200 may be any suitable type of electronic device 200 capable of computing a temperature-compensated working point 212. As examples, the electronic device 200 may be a processing unit of a vehicle, an Internet-of-Things controller, a mobile communication device (e.g., a smartphone, a laptop, a tablet, etc.), and the like. It is understood that the representation of the electronic device 200 in FIG. 2 may be simplified for the purpose of illustration, and the electronic device 200 may include additional components with respect to those shown.

In general, the electronic device 200 may include a processor 202 and a memory 204. The memory 204 may be communicatively coupled with the processor 202, and may be configured to store instructions (e.g., software instructions, program code) executed by the processor 202. The instructions may cause the processor 202 to perform an adapted method 210 for determining a temperature-compensated working point 212, described in further detail below. Aspects described with respect to a configuration of the processor 202 may also apply to the method 210, and vice versa. A functionality carried out by the processor 202 may correspond to a respective step of the method 210, and a step of the method 210 may correspond to a respective configuration of the processor 202 to carry out a functionality resulting in the method step. It is also understood that the processor 202 may include a single processor (e.g., a single circuit) configured to carry out the method 210, or may include a plurality of processors (sub-processors, or sub-circuits) each configured to carry out a portion of the method 210. For example, a first (sub-) processor may carry out a first function related to the method 210, a second (sub-) processor may carry out a second function related to the method 210, etc.

In a preferred configuration, considering typical application scenarios, the processor 204 may be configured to carry out software-based processing to implement the method 210, e.g. to determine the temperature-compensated working point 212. For example, the processor 204 may be a general purpose processor executing software instructions corresponding to the method 210. In some aspects, the processor 202 may be a microcontroller.

According to the proposed temperature-compensation scheme, the processor 202 may be configured to receive a temperature signal 222. The temperature signal 222 may be representative (in other words, indicative) of a temperature of a light emitting device. For example, the temperature signal 222 may be representative of a temperature value 214 of the temperature of the light emitting device (e.g., of a light emitting element). The temperature value 214 may be configured as the temperature value 114 described in relation to FIG. 1A to FIG. 1C, e.g. the temperature value 214 may be an instantaneous value of the temperature or an average value of the temperature. In some aspects, the temperature signal 222 may be representative of further properties of the temperature, e.g. a behavior over time of the temperature, a slope of the temperature, a gradient of the temperature, a maximum temperature value in a predefined time interval, a minimum temperature value in a predefined time interval, or any combination thereof.

The processor 202 may receive the temperature signal 222 directly from the light emitting device, e.g. from a driver circuit of the light emitting device. For example, the driver circuit (e.g., the driver circuit 106) may forward to the processor the measurement signal from a temperature sensor as temperature signal 222, or may forward the measurement signal from a voltage sensor as temperature signal 222. As another example, the driver circuit may process internally the measurement signal from the temperature sensor/voltage sensor and deliver to the processor 202 the result of the processing as temperature signal 222 representing the temperature value 214 (and, in some aspects, additional temperature properties). In other aspects, the processor 202 may receive the temperature signal 222 from an intermediate device that is communicatively interposed between the light emitting device and the electronic device 200.

In some aspects, the processor 202 may be configured to prompt the driver circuit of the light emitting device to transmit the temperature signal 222. For example, the processor 202 may determine that a temperature-compensation should be carried out, and may request the driver circuit to transmit the temperature signal 222. As an exemplary configuration, the processor 202 may be configured to determine the temperature-compensated working point 212 for the absolute first emission of light with a new color via the light emitting element of the light emitting device. Illustratively, before the light emitting element (or a plurality of light emitting elements) emit light with a color that was not emitted before, the processor 202 may carry out the temperature compensation, e.g. by requesting the temperature signal 222 and determining the temperature-compensated working point 212.

In other aspects, the driver circuit of the light emitting device may be configured to transmit the temperature signal 222 to the processor 202 at predefined time intervals, e.g. at regular time intervals, for example every 10 s, every 30 s, every minute, every 5 minutes, and the like.

The processor 202 may be further configured to determine, based on the temperature value 214 (illustratively, based on the temperature at which the light emitting device is operating) a temperature-compensated working point 212 for the light emitting device. As will be described in further detail in relation to FIG. 3A to FIG. 3C, the temperature-compensated working point 212 may include temperature-compensated current generation parameters for defining a driving profile for the light emitting element of the light emitting device. Illustratively, based on the known temperature value 214, the processor 202 may determine (e.g., calculate, define, specify) parameters to be used for driving the light emission by the light emitting element. As discussed in relation to FIG. 1A to FIG. 1C, such parameters may be further tuned by the internal temperature compensation carried out by the driver circuit of the light emitting device. The current generation parameters defined by the external device may also be referred to herein as “initial” current generation parameters, and the current generation parameters defined by the driver circuit may also be referred to as “final” current generation parameters.

As mentioned in relation to FIG. 1A to FIG. 1C further properties of the temperature may be considered in addition to the temperature value. Illustratively, in some aspects the processor 202 may be further configured to determine the temperature-compensated working point 212 further based on additional temperature parameters, in a corresponding manner as discussed above in relation to the driver circuit 106.

In general, the processor 202 may have greater computational power compared to the driver circuit of the light emitting device, so that the processing for determining the temperature-compensated working point 212 may be more computationally demanding compared to the internal adjustment around the temperature-compensated working point 212 carried out internally by the driver circuit. In the proposed scheme, the splitting of the processing ensures that a high accuracy is obtained by relying on the external processor that is capable of more complex calculations, and further ensures that the data flow between processor and driver circuit is not excessive by leaving the fine adjustments to the internal circuitry of the light emitting device.

Further details about a possible approach for determining the temperature-compensated working point 212 will be provided in relation to FIG. 3A to FIG. 3C. In general, the processor 202 may be configured to determine the temperature-compensated working point based on a known temperature dependence of the light emission by the light emitting element of the light emitting device. For example, the memory 204 may be configured to store information representative of the temperature dependence of the light emission by the light emitting element, and the processor 202 may retrieve such information to determine from the temperature value 214 a corresponding temperature-compensated working point 212.

After having determined the temperature-compensated working point 212, the processor 202 may be configured to cause a transmission of the temperature-compensated working point 212 to the light emitting device, e.g. to the driver circuit of the light emitting device. The transmission may be a direct transmission or an indirect transmission through an intermediate device.

FIG. 3A to FIG. 3C illustrate various aspects of defining a temperature-compensated working point and a driving profile for driving light emission by a light emitting element, according to various aspects. In general, an external loop 350 may be configured to carry out a temperature compensation to obtain a target chromaticity for the emitted light, and an internal loop 360 may be configured to carry out a temperature compensation to obtain a target brightness for the emitted light. In the following, the operation in the external loop 350 is described with reference to a processor 302 (of an external electronic device), and the operation in the internal loop 360 is described with reference to a driver circuit 306 (of a light emitting device). It is understood that the aspects described in relation to FIG. 3A to FIG. 3C apply in a corresponding manner to a configuration of the light emitting device 100 (e.g., of the driver circuit 106) and electronic device 200 (e.g., processor 202), and to the methods 110, 210 described in FIG. 1A to FIG. 2.

In general, a temperature-compensated working point 312 may define temperature-compensated current generation parameters 332, as discussed in relation to the temperature-compensated working point 112, 212 in FIG. 1A to FIG. 2. The temperature-compensated current generation parameters 332 may be parameters to define the driving profile for generating/delivering a driving current to the light emitting element. In a preferred configuration, the temperature-compensated current generation parameters 332 may be defined to obtain a target chromaticity of the emitted light. As another example, the temperature-compensated current generation parameters 332 may be defined to obtain a target color for the emitted light, or any other target property that may be of interest.

As generally known in the art, chromaticity diagrams have been defined to represent the hues perceivable by an average observer and evaluate a color against a gamut. Examples of color spaces are the so-called CIE 1931 RGB space and the CIE 1931 XYZ color space, defined by the International Commission on Illumination (CIE). A difference between the two color spaces is that the CIE 1931 XYZ color space is device-independent, and includes the color sensations that an average observer may perceive. As known, a chromaticity diagram represents visible colors using X as horizontal axis (to define a horizontal coordinate Cx), and Y as vertical axis (to define a vertical coordinate C_{Y}). The chromaticity diagram may thus represent the spectral colors and the results of their combination based on the primary colors red, green, and blue.

According to various aspects, the temperature-compensated working point 312 may thus define temperature-compensated current generation parameters 332 to cause light emission at target color coordinates in a predefined chromaticity diagram. In a preferred configuration, the predefined chromaticity diagram may be the CIE 1931 XYZ color space, because of its device-invariance. It is however understood that the aspects described herein may apply in a corresponding manner in case other color spaces are considered, e.g. the CIE 1931 RGB space.

Illustratively, the processor 302 may determine target coordinates in the predefined chromaticity diagram and may define temperature-compensated current generation parameters 332 to obtain such target coordinates based on the (current) temperature of the light emitting device and based on a known temperature dependence of the light emission by the light emitting element.

In principle, any suitable formula or algorithm may be used to determine the temperature-compensated working point 312 (and temperature-compensated current generation parameters 332). For example, in case sufficient computational power is available, the processor 202 may determine temperature-compensated working point 312 using a trained machine learning model. The trained machine learning model may receive, as input, the temperature of the light emitting device (e.g., the temperature value, and/or the behavior over time), and may deliver, as output, the temperature-compensated current generation parameters 332. For example, the trained machine learning model may have as optimization target a chromaticity to be obtained, or other suitable optimization targets such as the color of the emitted light.

In a preferred configuration, which may provide a computationally simpler, yet accurate determination of the temperature-compensated working point 312, the processor 302 may be configured to determine the temperature-compensated working point 312 using a set of quadratic compensation functions. The quadratic compensation functions may have as parameters, the temperature value of the temperature of the light emitting device (e.g., of the light emitting element), and a calibration temperature. An example of quadratic compensation function is provided in Equation (1)

f(T)=[a(T−T_{cal})²+b(T−T_{cal})+1]×f(T_{cal}) (1)

where f is any calibration value, and T_{cal} is the temperature value of the calibration temperature, i.e. of the temperature at which the optical calibration of the light emitting device was carried out. The calibration temperature may thus be associated with the light emitting device, e.g. may be specific to the light emitting device, or may be common to a batch of light emitting devices.

The processor 302 may thus use the quadratic compensation functions to determine a temperature-compensated calibration value or a plurality of temperature-compensated calibration values, based on which the processor r 302 may determine the temperature-compensated working point 312. Illustratively, calibration data are scaled to the estimated temperature of the light emitting element using the formula (1) above, and the processor 302 may (re) calculate temperature-compensated current generation parameters 332 (e.g., PWM values, such as duty cycle, frequency) using the new calibration data. As mentioned, in a first approximation the temperature of the light emitting device (e.g., the temperature of the integrated circuit) and the temperature of the light emitting element (e.g., of the LED) may be assumed to be equal to one another.

The processor 302 may thus use the temperature dependence of the coordinates in the chromaticity diagram of the light emitting element to (re) calculate temperature-compensated current generation parameters 332 (e.g., PWM values) for a given target point based on the temperature of the light emitting device. The coordinates in the chromaticity diagram may include for example three coordinate values, namely C_{X}, C_{Y}, and I_{V}, corresponding respectively to an X-coordinate, Y-coordinate, and intensity value for the light.

Turning now to the internal loop 360, the driver circuit 306 may be configured to determine a temperature compensation factor 334 based on the temperature of the light emitting device. The temperature compensation factor 334 may be an adjustment factor to modify the temperature-compensated current generation parameters 332 and obtain the (final) current generation parameters 336 for the driving profile 316 to drive the light emission. Illustratively, the temperature-compensated current generation parameters 332 may define the working point around which the driver circuit 306 further compensates for small temperature changes, e.g. to compensate self-heating effects taking place after the external correction. The driver circuit 306 may thus determine the current generation parameters 336 for the driving profile 316 by modifying the temperature-compensated current generation parameters 332 of the working point using the temperature compensation factor 334.

In a preferred configuration, the temperature compensation factor 334 may define an adjustment (in other words, a variation) of the temperature-compensated current generation parameters 332 to obtain a target brightness of the emitted light. Illustratively, brightness compensation may be computationally simpler compared to identifying color coordinates, so that brightness compensation may be assigned to the internal loop 360. The driver circuit 306 may thus be configured to define the temperature compensation factor 334 based on a known temperature-dependence of the brightness of the light emitted by the light emitting element, to adjust the temperature-compensated current generation parameters 332 (e.g., the PWM values) around the set point.

In general, the internal temperature compensation may be computationally simpler compared to the external temperature compensation. In a preferred configuration, the temperature compensation factor 334 may be a linear compensation factor, e.g. may define a linear scaling factor for the temperature-compensated current generation parameters 332. As mentioned, the temperature-compensated current generation parameters 332 may include in a preferred configuration PWM parameters, e.g. duty cycle, frequency, and the like, so that the temperature compensation factor 334 may define a linear scaling of the duty cycle, of the frequency, etc. around to set point defined by the external loop 350. Considering another case in which the temperature-compensated current generation parameters 332 include an amplitude modulation of the driving current, the temperature compensation factor 334 may define a linear scaling of the amplitude modulation around the set point.

Considering the PWM scenario, the driver circuit 306 may calculate the corrected PWM value according for example to Equation (2),

PWM(T)=PWM(T_{ref})[1+α(T_{ref})(T−T_{ref})] (2)

where T is temperature of the light emitting device received at the driver circuit, T_{ref} is a reference temperature, and α is the linear compensation factor (an example of temperature compensation factor 334).

The reference temperature may be the temperature of the light emitting device when engaging the external loop 350, illustratively the temperature used by the external processor 302 for defining the temperature-compensated working point 312. The driver circuit 306 may thus perform further small adjustments based on a difference occurred between the temperature at the time of calculating the temperature-compensated working point 312 and the (further) temperature at the time of determining the driving profile 316. For example, the driver circuit 306 may cause a storing of the temperature indicated by the temperature signal (as reference temperature) when transmitting the temperature signal to the external electronic device. The reference temperature may be stored in a memory of the light emitting device, e.g. in a register.

The driver circuit 306 may thus determine the (actual) current generation parameters 336 from the temperature-compensated current generation parameters 332 based on the (linear) temperature compensation factor 334 (a) and the difference between the reference temperature and the (current) temperature of the light emitting device. With reference to FIG. 1A to FIG. 1C, the driver circuit 306 may determine the driving profile for driving the light emission based on a (further) temperature (and further temperature value) compared to the temperature based on which the external processor defined the temperature-compensated working point. The driver circuit 306 may thus compensate for variations between the temperature considered by the external processor and the further temperature considered by the driver circuit 306.

Considering the scenario in which the light emitting device includes a plurality of light emitting elements (e.g., RGB LEDs), the temperature-compensated current generation parameters 332 may be configured to obtain a target chromaticity of emitted light as a mixing of light emitted by the plurality of light emitting elements. Illustratively, having a color space in mind, the temperature-compensated current generation parameters 332 may define the contribution of the different light emitting elements to obtain a target color in the color space. In this scenario, the temperature compensation factor 334 may include a plurality of temperature compensation factors, one for each light emitting element, to define a respective adjustment of the temperature-compensated current generation parameters 332 and obtain respective (actual) current generation parameters 336. A temperature compensation factor 334 associated with a light emitting element may be configured to define (achieve) a target brightness for the light emitted by that light emitting element.

In various aspects, the temperature compensation factor 334 (e.g., the linear compensation factor α) may be preprogrammed in the light emitting circuit, e.g. may be programmed by a user individually for every light emitting element (every LED). In a preferred configuration, as shown in FIG. 3B, the temperature compensation factor 334 may be a derivative of the duty cycle of the pulse width modulation with respect to the temperature of the light emitting device.

FIG. 3B shows a first graph 370a indicating for the three primary colors red (represented by a first curve 372a), green (represented by a second curve 374a), and blue (represented by a third curve 376a), a PWM duty cycle for different temperatures, and a corresponding determination of a temperature-compensated PWM duty cycle using a quadratic compensation function (PWM (T)=a+bT+cT²+dT³+eT⁴). Furthermore, FIG. 3B shows a second graph 370b indicating for the three primary colors red (represented by a first curve 372b), green (represented by a second curve 374b), and blue (represented by a third curve 376b), a linear compensation factor at different temperatures, determined as the derivative of the PWM duty cycle with respect to temperature, as

$$α ( T ) = \frac{dPWM ( T )}{d T} = b + 2 c T + 3 d {T}^{2} + 4 e {T}^{3} .$$

The compensation factor may thus be the derivative of the PWM value (duty cycle) with respect to the driver or ambient temperature. The fourth-order polynomial fit may provide a smooth function for α.

As mentioned in relation to FIG. 1A, in some aspects a voltage at driving terminals of the light emitting element (in some aspects, a forward voltage of a LED) may be used instead or in addition to a direct reading of the temperature. The exemplary scenario with LEDs is illustrated in FIG. 3C, which shows a first graph 380a indicating for the three primary colors red (represented by a first curve 382a), green (represented by a second curve 384a), and blue (represented by a third curve 386a), a PWM value for a voltage difference between the forward voltage currently present at the LEDs and a reference forward voltage.

The y-axis of the graph 380a shows the PWM value normalized to the reference value, illustratively

$$\frac{PWM ( Δ {V}_{F} )}{{PWM}_{c a l}} ,$$

where PW Mcal is the PWM value at the calibration temperature. The x-axis shows ΔV_{F}=V_{F}(T)−V_{F}(T_{cal}). Illustratively, the graph 380a represents relative variations in the PWM value with respect to a corresponding forward voltage difference between the currently present forward voltage and the forward voltage at the calibration temperature. The normalized PWM value may be expressed as

$$\frac{PWM ( Δ {V}_{F} )}{{PWM}_{c a l}} = a \times {e}^{- b Δ {V}_{F}} + c ,$$

thus leading to F(ΔV_{F})=−a×b×e^{-b ΔV}^{_{F}}.

Furthermore, FIG. 3C shows a second graph 380b indicating for the three primary colors red (represented by a first curve 382b), green (represented by a second curve 384b), and blue (represented by a third curve 386b), a corresponding compensation factor (y-axis) plotted against the forward voltage difference between the currently present forward voltage and the forward voltage at the calibration temperature (x-axis). The compensated PWM value may be expressed as PWM(ΔV_{F})=PWM_{cal}[1+F(ΔV_{F,ref})(ΔV_{F}−ΔV_{F,ref})].

According to various aspects, various “triggering conditions” may be implemented to trigger an execution of the temperature compensation, thus providing a smart and flexible process.

In various aspects, the internal loop 360 may be triggered when the temperature measurement exceeds a given threshold compared to a reference temperature taken when a new working point 312 was programmed by the external processor 302 (e.g., the reference temperature taken when a new PWM setting was programmed by the external microcontroller). Illustratively, the driver circuit 306 may receive the working point 312, and may get the (further) temperature value of the light emitting device after having received the working point 312. The driver circuit 306 may further compare the (further) temperature value with a reference temperature value corresponding to the temperature based on which the external processor 302 generated the working point 312. The driver circuit 306 may then directly use the working point 312 (and the “initial” current generation parameters) if the difference between the (further) temperature value and the reference temperature value is less than a predefined threshold. Alternatively, the driver circuit 306 may adjust the working point 312 (providing the “final” current generation parameters using the temperature compensation factor 334) if the difference between the (further) temperature value and the reference temperature value is greater than the predefined threshold.

The driver circuit 306 may thus be configured to determine the temperature compensation factor 334 if a difference between the temperature of the light emitting device and a previously determined temperature of the light emitting device (as used by the external processor 302 to determine the working point 312) is greater than the predefined threshold. Considering the scenario in which the working point 312 defines PWM values, the driver circuit 306 may calculate a temperature compensated PWM value when the (further) temperature measurement exceeds a given threshold, compared to the reference temperature taken when a new PWM setting was programmed by the processor 302. The predefined threshold may be selected to have any suitable value by balancing the accuracy of the temperature compensation with a consumption of resources, e.g. taking into consideration the temperature dependence of the behavior of the light emitting element(s). As a numerical example, the predefined threshold may be in the range from 0.25° C. to 10° C., for example in the range from 0.5° C. to 5° C., for example in the range from 1° C. to 2° C. The predefined threshold may be fixed, or may be programmable. In case of a programmable threshold, the driver circuit 306 may receive a signal indicative of the threshold to be used (e.g., by the external device, or another device), and set the threshold accordingly.

The temperature threshold approach may be correspondingly adapted to a voltage at the driver terminals of the light emitting element(s), e.g. to the forward voltage of a LED. In a corresponding manner, the driver circuit 306 may directly use the working point 312 (and the “initial” current generation parameters) if the difference between the (further) voltage value and a reference voltage value is less than a predefined threshold. Alternatively, the driver circuit 306 may adjust the working point 312 (providing the “final” current generation parameters using the temperature compensation factor 334) if the difference between the (further) voltage value and the reference voltage value is greater than the predefined threshold. The reference voltage value may be the voltage value considered by the external device for the temperature-compensated working point 312. In case of a RGB application, relative variation of the forward voltage in each LED may be considered to trigger a new correction factor or a linear combination of the forward voltage of the LEDs may be used.

In other aspects, the driver circuit 306 may be configured to carry out the internal temperature compensation at given time intervals. Illustratively, independently of whether the difference between the (further) temperature value and the reference temperature value is greater than the predefined threshold, the driver circuit 306 may determine the temperature compensation factor 334 if a predefined time period has elapsed for a previous determination of the temperature compensation factor. The predefined time period may be freely adapted according to system considerations, as discussed above for the temperature threshold. As a numerical example, the predefined time period may have a duration in the range from 30 seconds to 10 minutes, for example in the range from 1 minute to 5 minutes. The current generation parameters (e.g., the PWM values) may thus be updated in the driver 306 at given time intervals (instead of temperature difference), which may be regular or triggered by any event inside the driver 306.

FIG. 4A shows a system 400 including a light emitting device 410 and an (external) electronic device 440 communicatively coupled with one another, according to various aspects. The light emitting device 410 may be configured as the light emitting device 100 described in FIG. 1A to FIG. 1C, and may include a light emitting element 402 configured to emit light 404, and a driver circuit 406 configured to drive the light emission by the light emitting element 402. The driver circuit 406 may be configured as the driver circuit 106, 306 described in relation to FIG. 1A to FIG. 1C, and in relation to FIG. 3A. It is understood that the light emitting device 410 may have any suitable configuration described in FIG. 1A to FIG. 1C, e.g. the light emitting device 410 may further include a temperature sensor and/or a voltage sensor, or a plurality of light emitting elements (e.g., RGB LEDs), and the like. In a corresponding manner, the electronic device 440 may be configured as the electronic device 200 described in FIG. 2, and may include a processor 442 and a memory 444. The processor 442 may be configured as the processor 202, 302 described in FIG. 2 and FIG. 3A.

It is understood that the aspects described in relation to the system 400 may apply in a corresponding manner to the individual devices, i.e. the individual light emitting device 100, 410 and the individual electronic device 200, 440.

The general operation of the light emitting device 410 and (external) electronic device 440 with regard to temperature-compensated light emission may correspond to the aspects already described, so that a repetition of the concepts will be dispensed with. In brief, the processor 442 may carry out an initial temperature compensation by receiving a temperature signal 422 representing the temperature of the light emitting device 410 (e.g., a temperature value of the temperature), and by determining a temperature-compensated working point 412 (including temperature-compensated current generation parameters, e.g. PWM values) based on the temperature of the light emitting device 410.

The driver circuit 406 of the light emitting device 410 may receive the externally defined temperature-compensated working point 412, and may determine a driving profile 416 for driving the light emission based on the temperature-compensated working point 412 and on a (further) temperature value of the temperature of the light emitting device 410. For example, the driving profile 416 may include (actual) current generation parameters determined by adjusting the temperature-compensated current generation parameters using a temperature compensation factor. The driver circuit 406 may further generate/deliver driving current to the light emitting element 402 according to the driving profile 406 (illustratively, generating driving current according to the current generation parameters).

In general, the light emitting device 410 and the electronic circuit 440 may be communicatively coupled with one another via a communication interface. In a preferred configuration the light emitting device 410 and the electronic circuit 440 may be coupled in a direct manner, i.e. without interposed devices, thus allowing a faster and more robust communication. In principle, however, the light emitting device 410 and the electronic circuit 440 may be communicatively coupled in an indirect manner, with one or more further devices interposed therebetween.

In an exemplary configuration, the communication interface may be configured for wired communication, e.g. the light emitting device 410 and the external electronic device 440 may be communicatively coupled with one another over a wired communication bus. For example, the communication interface may include one or more electrically conductive lines to enable wire-based communication. Any suitable wired communication protocol may be used, such as the Inter-Integrated Circuit bus (I²C) protocol, the Serial Peripheral Interface (SPI) protocol, the single-wire (1-wire, or one-wire) protocol, the Controller Area Network (CAN) protocol, the Ethernet protocol, and/or the microwire protocol, as examples.

In another configuration, the communication interface may be configured for wireless communication, e.g. the light emitting device 410 and the external electronic device 440 may be communicatively coupled with one another in a wireless manner. In this case, the light emitting device 410 and the electronic device 440 may include circuitry to enable the wireless communication, e.g. including one or more antennas, one or more transceivers, one or more amplifiers, one or more filters, and the like. Any suitable wireless communication protocol may be used, such as WiFi, Near Field Communication (NFC), Bluetooth, Bluetooth Low Energy, Zigbee, RFID, as examples.

Wireless communication may be for example used in the context of an Internet-of-Things environment, in which a lighting fixture (e.g., for ambient illumination at home) is controlled via a smartphone or other type of mobile communication device. In this case the smartphone may be the external electronic device carrying out the initial steps of the temperature compensation.

In various aspects, as shown for the configuration 400b in FIG. 4B, the system 400 may include a plurality of light emitting devices 410 communicatively coupled with the electronic device 440. In the exemplary configuration in FIG. 4B, the system 400 may include a first light emitting device 410a, a second light emitting device 410b, and a third light emitting device 410c, but it is understood that the system 400 may include any suitable number of light emitting devices.

In this scenario, the external processor 442 may receive the temperature of each of the plurality of light emitting devices 410, or of a subset of the plurality of light emitting devices 410. For example, the external processor 442 may receive a respective temperature signal 422a, 422b, 422c for each of the light emitting devices 410. As another example, the external processor 442 may receive a single temperature signal representative of the temperature of the plurality of light emitting devices 410 (e.g., individual temperatures, or an average temperature).

The external processor 442 may determine a temperature-compensated working point for each of the plurality of light emitting devices 410, or for the subset of the plurality of light emitting devices 410. For example the external processor 442 may determine a respective temperature-compensated working point 412a, 412b, 412c for each of the light emitting devices 410. As another example, the external processor 442 may determine a single temperature-compensated working point common to the plurality of light emitting devices 410. The respective driver circuit 306 of each light emitting device 410 may then determine a respective driving profile 416a, 416b, 416c for driving the light emission of the respective light emitting element 402.

In some aspects, the external electronic device 440 may be communicatively coupled with each of the plurality of light emitting devices 410 via a respective communication interface. In other aspects, the external electronic device 440 may be communicatively coupled with one of the plurality of light emitting devices 410, and the light emitting devices 410 may be communicatively coupled with one another, so that the light emitting device that communicates with the external processor 442 may act as a hub to transfer information from the other light emitting devices towards the processor 442 and vice versa.

In a preferred configuration, the plurality of light emitting devices 410 may be arranged in a “daisy chain topology”. In a daisy chain configuration the light emitting devices 410 may be connected to form a series of nodes, in which each light emitting device 410 may be connected via a point-to-point connection with one or two further light emitting devices 410. In this configuration, the light emitting devices 410 may form a network, in which each light emitting device 410 defines a network node.

A “daisy chain topology” may be “linear”, such that a first node is connected to a second node, the second node is further connected to a third node, the third node is further connected to a fourth node, etc. until the final node of the series is reached. The “linear configuration” may thus be a bidirectional network configuration in which each network node is connected to the next in the series (illustratively, in a line, or chain), and the communication runs through the series of connected nodes and then returns along the same path. In this configuration the first node and the last node are not directly connected.

As another example a “daisy chain topology” may have a “ring configuration”, such that a first node is connected to a second node, the second node is further connected to a third node, the third node is further connected to a fourth node, etc. and the final node of the series is connected back to the first node. The “ring configuration” may thus define a loop-back network, in which the network nodes are connected in series, and the last node is connected back to the first node, so that communication runs through the sequence of nodes in one direction and then loops back to the first node. In the ring topology, every network node may thus be connected to two other nodes, with the first node and the last node being connected to one another.

In a daisy chain configuration the light emitting devices 410 may communicate with one another according to a wired communication protocol for serial communication. An example of such protocol is the Open System Protocol (e.g., according to OSIRE® E3731i-Open System Protocol 1.0, Application Note AN162 of 2023 Jul. 6). The OSP protocol may be particularly suitable for managing communication in daisy chain networks, e.g. in daisy chains of light emitting devices 410.

In serial communication, a network node may be the “primary node”, and may configured to control the operation of the other network nodes. The “primary node” may thus be configured to govern the transmission and the reception of data in the network, e.g. a “primary node” may be configured to transmit data to one or more other “secondary nodes” and may be configured to request the transmission of data from the one or more other “secondary nodes”. The other nodes may be “secondary nodes” and may receive instructions from the primary node and respond to the received instructions (e.g., without performing any active data transmission in absence of a prompt from the primary node). In this scenario, the external electronic device 440 may be communicatively coupled with the primary node, and the primary node may manage the data flow to and from the secondary nodes of the network.

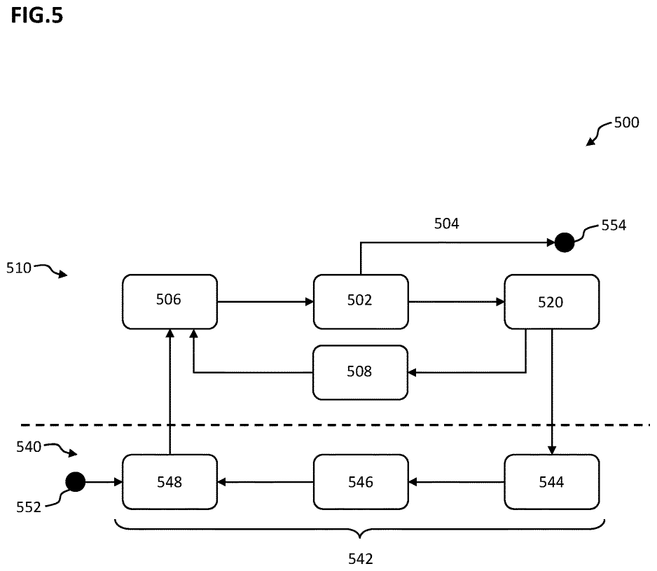

FIG. 5 shows a system 500 including a light emitting device 510 and an external electronic device 540 communicatively coupled with one another. The system 500 may be an exemplary realization of the system 400, including an exemplary realization of the light emitting device 100, 410 and electronic device 200, 440.

The light emitting device 510 may include a light emitting diode 502, e.g. including a single LED or a plurality of LEDs, for example RGB LEDs, configured to emit light 504. The light emitting device 510 may further include a LED driver 506 (including PWM) configured to drive the light emission by the LED 502. The light emitting device 510 may further include a temperature sensor 520 configured to sense a temperature of the LED 502 and deliver a corresponding measurement signal representing the IC temperature as output.

The electronic device 540 may include a processor 542 including various sub-processors configured to carry out various functionalities for the temperature-compensation. The electronic device 540 may be a microcontroller unit, carrying out software processing for the temperature-compensation. For example, the processor 542 may include a temperature estimation circuit 544 configured to receive a temperature signal indicative of the IC temperature from the light emitting device 510 (e.g., from the temperature sensor 520). The temperature estimation circuit 544 may deliver, as output signal, the LED temperature (e.g., assumed to be equal to the IC temperature, or determined via suitable correction factors).

The processor 542 may further include a temperature compensation circuit 546 configured to use compensation functions (e.g., quadratic compensation functions) to determine color coordinates (C_{X}, C_{Y}, I_{V}) based on the LED temperature as received from the temperature estimation circuit 542. The processor 542 may further include a color mixing circuit 548 configured to receive the corrected color coordinates from the temperature compensation circuit 546 and deliver, as output, a temperature-compensated working point to the LED driver 506, e.g. PWM values. The color mixing circuit 548 may determine the temperature-compensated working point using a color mixing algorithm, e.g. based on target optimization parameters 552 such as target color coordinates (to provide target color and brightness). For example, the color mixing circuit 548 may use calibration data of the light emitting device for the calculation, e.g. data stored in a memory of the electronic device 540, such as in a one-time programmable (OTP) memory.

The color mixing circuit 548 may deliver the temperature-compensated working point to the LED driver 506. The light emitting circuit 510 may further include a PWM correction circuit 508 configured to receiver the IC temperature from the temperature sensor 520 and deliver, as output to the LED driver, a PWM correction. The LED driver 506 may apply the PWM (internal) correction to the PWM values received from the color mixing circuit 548 to drive the LED 502 and obtain a target optical output spectrum 554.

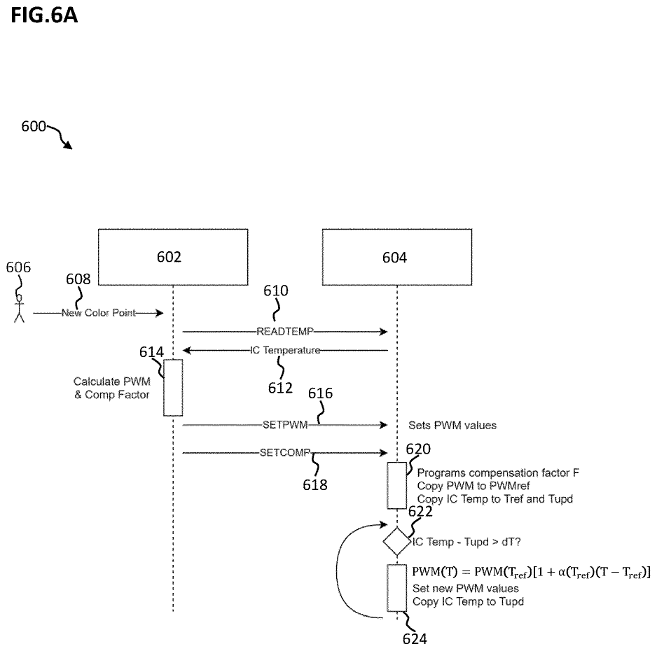

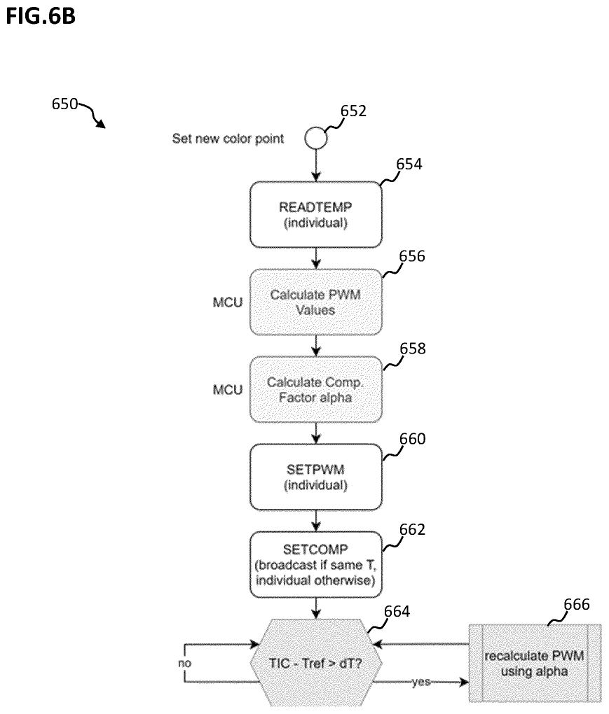

FIG. 6A and FIG. 6B shows an exemplary message flow diagram 600 between a processor 602 (of an external device) and a driver circuit 604 (of a light emitting device) in the context of a method 650 of temperature-compensated light emission. The message flow diagram 600 may show an exemplary data flow of the temperature compensation proposed herein, and the flow diagram 650 may show an exemplary realization of the proposed temperature compensation.

The method 650 may start, in 652, with a user 606 setting a new color point to be obtained for the emitted light. The user 606 (e.g., via a user device) may transmit a color signal 608 to the processor 602 to set the new color point. The method 650 may further include, in 654, reading the temperature of the light emitting device. Illustratively, upon receiving the color signal 608 from the user 606, the processor 602 may transmit a temperature request signal 610 to the driver circuit, to prompt the driver circuit 604 to transmit a temperature response signal 612 (illustratively, a temperature signal) representative of the IC temperature.

The method 650 may further include, in 656 and 658, calculating PWM values and compensation factor α. Illustratively, the processor 602 may further carry out a calculation 614 to determine PWM values and a compensation factor (e.g., using quadratic compensation functions). The method 650 may further include, in 660 and 662, transmitting the PWM values and compensation factor to the driver circuit. Illustratively, the processor 602 may then transmit a PWM setting signal 616 including the PWM values to the driver circuit 604, and further may transmit a compensation factor signal 618 representative of the compensation factor α.

Upon receiving the PWM setting signal 616 and the compensation factor signal 618, the driver circuit 604 may carry out an internal calculation 620 to program the temperature compensation factor F. The driver circuit 604 may further copy the PWM values and store them as reference PWM values, and further copy the temperature considered by the processor 602 as reference temperature.

The method 650 may further include, in 664, determining whether a temperature difference is greater than a predefined threshold. Illustratively, the driver circuit 622 may then carry out a temperature check 622 to determine whether a difference between the reference temperature and the current temperature of the IC is greater than a threshold difference. If yes, the method 650 may include, in 666, recalculating the PWM values using the internally determine temperature correction factor. Illustratively, the driver circuit 604 may carry out an adjustment 624 of PWM values to set new PWM values.

The terms “processor”, “processing circuit”, or “control circuit” as used herein may be understood as any kind of technological entity that allows handling of data. The data may be handled according to one or more specific functions that the processor/processing circuit/control circuit may execute. Further, a processor/processing circuit/control circuit as used herein may be understood as any kind of circuit, e.g., any kind of analog or digital circuit. A processor/processing circuit/control circuit may thus be or include an analog circuit, digital circuit, mixed-signal circuit, logic circuit (e.g., a hard-wired logic circuit or a programmable logic circuit), microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. It is understood that any two (or more) of the processors/processing circuits/control circuits detailed herein may be realized as a single entity with equivalent functionality or the like, and conversely that any single processor/processing circuit/control circuit detailed herein may be realized as two (or more) separate entities with equivalent functionality or the like.

The term “memory” as used herein may be understood as a computer-readable medium (e.g., a non-transitory computer-readable medium), in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, among others, or any combination thereof. Registers, shift registers, processor registers, data buffers, among others, are also embraced herein by the term memory.

The term “connected” may be used herein with respect to terminals, integrated circuit elements, devices, and the like, to mean electrically connected, which may include a direct connection or an indirect connection, wherein an indirect connection may only include additional structures in the current path that do not influence the substantial functioning of the described circuit or device. The term “electrically conductively connected” that is used herein to describe an electrical connection between one or more terminals, devices, regions, contacts, etc., may be understood as an electrically conductive connection with, for example, ohmic behavior, e.g. provided by a metal or degenerate semiconductor in absence of p-n junctions in the current path. The term “electrically conductively connected” may be also referred to as “galvanically connected”. The term “coupled” may be used herein in the same manner as the term “connected”.

The word “exemplary” is used herein to mean “serving as an example, instance, or illustration”. Any embodiment or design described herein as “exemplary” is not necessarily to be construed as preferred or advantageous over other embodiments or designs.

The phrase “at least one” and “one or more” may be understood to include a numerical quantity greater than or equal to one (e.g., one, two, three, four, [ . . . ], etc.). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

Unless specified otherwise, the term “subset” in relation to a group of elements may be understood to include a numerical quantity equal to or greater than one and less than a total number of the implied elements. Considering for example a group of ten elements, a “subset” of the group may include one, two, three, four, five, six, seven, eight, or nine elements. The term “subset” in relation to a group may thus describe a “proper subset” of the group, so that all the elements of the subset belong to the group, but at least one element of the group does not belong to the subset.

All acronyms defined in the above description additionally hold in all claims included herein.

While the invention has been particularly shown and described with reference to specific aspects, it should be understood by those skilled in the art that various changes in form and detail may be made therein without departing from the spirit and scope of the invention as defined by the appended claims. The scope of the invention is thus indicated by the appended claims and all changes, which come within the meaning and range of equivalency of the claims, are therefore intended to be embraced.

List of reference signs

| | |
|---|---|
| 100 | Light emitting device |
| 100b | Configuration of the light emitting |
| | device |
| 100c | Configuration of the light emitting |
| | device |
| 102 | Light emitting element |
| 102a | First light emitting element |
| 102b | Second light emitting element |
| 102c | Third light emitting element |
| 104 | Emitted light |
| 106 | Driver circuit |
| 110 | Temperature compensation method |
| 112 | Temperature-compensated working |
| | point |
| 114 | Temperature value |
| 116 | Driving profile |
| 116a | First driving profile |
| 116b | Second driving profile |
| 116b | Third driving profile |
| 120 | Temperature sensor |
| 122 | Measurement signal |
| 200 | Electronic device |
| 202 | Processor |
| 204 | Memory |
| 210 | Temperature compensation method |
| 212 | Temperature-compensated working |
| | point |
| 214 | Temperature value |
| 222 | Temperature signal |
| 302 | Processor |
| 306 | Driver circuit |
| 312 | Temperature-compensated working |
| | point |
| 316 | Driving profile |
| 332 | Temperature-compensated current |
| | generation parameters |
| 334 | Temperature compensation factor |
| 336 | Current generation parameters |
| 350 | External loop |
| 360 | Internal loop |
| 370a | Graph |
| 372a | Red curve |
| 372b | Red curve |
| 374a | Green curve |
| 374b | Green curve |
| 376a | Blue curve |
| 376b | Blue curve |
| 380a | Graph |
| 382a | Red curve |
| 382b | Red curve |
| 384a | Green curve |
| 384b | Green curve |
| 386a | Blue curve |
| 386b | Blue curve |
| 400 | System |
| 400b | System configuration |
| 402 | Light emitting element |
| 404 | Emitted light |
| 406 | Driver circuit |
| 410 | Light emitting device |
| 410a | Light emitting device |
| 410b | Light emitting device |
| 410c | Light emitting device |
| 412 | Temperature-compensated working |
| | point |
| 412a | Temperature-compensated working |
| | point |
| 412b | Temperature-compensated working |
| | point |
| 412c | Temperature-compensated working |
| | point |
| 416 | Driving profile |
| 416a | Driving profile |
| 416b | Driving profile |
| 416c | Driving profile |
| 422 | Temperature signal |
| 440 | Electronic device |
| 442 | Processor |
| 444 | Memory |
| 500 | System |
| 502 | LED |
| 504 | Emitted light |
| 506 | LED driver |
| 508 | PWM correction circuit |
| 510 | Light emitting device |
| 540 | Electronic device |
| 542 | Processor |
| 544 | Temperature estimation circuit |
| 546 | Temperature compensation circuit |
| 548 | Color mixing circuit |
| 552 | Target parameters |
| 554 | Output spectrum |
| 600 | Message flow diagram |
| 602 | Processor |
| 604 | Driver circuit |
| 606 | User |
| 608 | Color signal |
| 610 | Temperature request |
| 612 | Temperature answer |
| 614 | Calculation of PWM values |
| 616 | PWM setting signal |
| 618 | Compensation factor signal |
| 620 | Internal calculation |
| 622 | Temperature check |
| 624 | Adjustment of PWM values |
| 650 | Method |
| 652 | Method start |
| 654 | Method step |
| 656 | Method step |
| 658 | Method step |
| 660 | Method step |
| 662 | Method step |
| 664 | Method step |
| 666 | Method step |

1. A light emitting device comprising:
a light emitting element configured to emit light; and
a driver circuit configured to:
receive a temperature-compensated working point for defining a driving profile for driving a light emission by the light emitting element,
wherein the temperature-compensated working point is determined by an external electronic device disposed externally to the light emitting device;
get a temperature value of a temperature of the light emitting device;
define the driving profile based on the temperature-compensated working point and on the temperature value of the temperature of the light emitting device; and
generate driving current for driving the light emitting element according to the defined driving profile.

2. The light emitting device according to claim 1,
wherein the temperature-compensated working point defines temperature-compensated current generation parameters; and
wherein the driver circuit is further configured to:
determine, based on the temperature value of the temperature of the light emitting device, a temperature compensation factor for the temperature-compensated current generation parameters; and
determine current generation parameters of the driving current profile by modifying the temperature-compensated current generation parameters using the temperature compensation factor.

3. The light emitting device-according to claim 2,
wherein the temperature-compensated current generation parameters define a target chromaticity for the emitted light; and
wherein the temperature compensation factor defines an adjustment of the temperature-compensated current generation parameters to obtain a target brightness of the emitted light.

4. The light emitting device according to claim 2,
wherein the temperature compensation factor defines a linear scaling factor for the temperature-compensated current generation parameters.

5. The light emitting device according to claim 2,
wherein the current generation parameters comprise pulse width modulation, parameters of the driving profile; and
wherein the driver circuit is configured to generate driving current for driving the light emitting element according to the pulse width modulation parameters.

6. The light emitting device-according to claim 5,
wherein the temperature compensation factor is a derivative of the duty cycle of the pulse width modulation with respect to the temperature of the light emitting device.

7. The light emitting device according to claim 2,
wherein the driver circuit is further configured to determine the temperature compensation factor if a difference between the temperature of the light emitting device and a reference temperature used by the external electronic device to determine the temperature-compensated working point is greater than a predefined threshold.

8. The light emitting device according to claim 2,
wherein the driver circuit is further configured to determine the temperature compensation factor if a predefined time period has elapsed from a previous determination of the temperature compensation factor.

9. The light emitting device according to claim 1,
wherein the light emitting element-comprises a plurality of light emitting elements, each configured to emit light in a respective wavelength range;
wherein the temperature-compensated working point comprises a respective temperature-compensated working point for defining a respective driving profile for driving a light emission by each of the light emitting elements,
wherein the driver circuit is further configured to:
define the respective driving profile of each light emitting element based on the respective temperature-compensated working point and on the temperature value of the temperature of the light emitting device; and
generate a respective driving current for driving each light emitting element according to the respective driving profile.

10. The light emitting device according to claim 1;
further comprising a temperature sensor configured to sense a temperature of the light emitting device;
wherein the driver circuit is configured to get the temperature of the light emitting device by receiving a measurement signal representative of the sensed temperature from the temperature sensor.

11. The light emitting device according to claim 1,
wherein the driver circuit is configured to get the temperature of the light emitting device as a function of a voltage at driver terminals of the light emitting element.

12. The light emitting device according to claim 1,
wherein the light emitting element is or comprises a light emitting diode, LED.

13. A system comprising:
the light emitting device according to claim 1; and
the external electronic device communicatively coupled with the light emitting device;
wherein the external electronic device comprises a processor configured to:
receive a temperature signal indicative of a temperature of the light emitting device;
determine, based on a temperature value of the temperature of the light emitting device, the temperature-compensated working point for defining the driving profile; and
transmit the determined temperature-compensated working point to the driver circuit of the light emitting device.

14. A method of temperature-compensated light emission, the method comprising:
receiving at a light emitting device a temperature-compensated working point for defining a driving profile for driving a light emission by a light emitting element of the light emitting device,
wherein the temperature-compensated working point is generated externally to the light emitting device;
defining at the light emitting device the driving profile based on the temperature compensated working point and on a temperature value of a temperature of the light emitting device; and
generating driving current for driving the light emitting element according to the defined driving profile.

15. The method according to claim 14, further comprising:
determining, externally to the light emitting device and based on a temperature value of a temperature of the light emitting device, the temperature-compensated working point for defining the driving profile for driving the light emission by the light emitting element of the light emitting device.

16. The method according to claim 14,
wherein the temperature-compensated working point defines temperature-compensated current generation parameters; and
wherein the method further comprises:
determining, based on the temperature value of the temperature of the light emitting device, a temperature compensation factor for the temperature-compensated current generation parameters; and
determining current generation parameters of the driving current profile by modifying the temperature-compensated current generation parameters using the temperature compensation factor.

17. The method according to claim 16,
wherein the temperature-compensated current generation parameters define a target chromaticity for the emitted light; and
wherein the temperature compensation factor defines an adjustment of the temperature-compensated current generation parameters to obtain a target brightness of the emitted light.

18. The method according to claim 16,
wherein the temperature compensation factor defines a linear scaling factor for the temperature-compensated current generation parameters.

19. The method according to claim 16,
wherein the current generation parameters comprise pulse width modulation, PWM, parameters of the driving profile; and
wherein the method further comprises generating driving current for driving the light emitting element according to the pulse width modulation parameters.

20. The method according to claim 19,
wherein the temperature compensation factor is a derivative of the duty cycle of the pulse width modulation with respect to the temperature of the light emitting device.
